(19) United States
(12) Patent Application Publication
(10) Pub. No.: US 2026/0295380 A1
(43) Pub. Date: Oct. 1, 2026

(54) Grip-Adjustable Claw Unit of a Claw Machine

(71) Applicant: Feiloli Electronic Co., Ltd., Changhua County (TW)

(72) Inventors: Chi-Ming Tsai, Changhua County (TW); I-Chiang Yang, Changhua County (TW)

(21) Appl. No.: 19/090,821

(22) Filed: Mar. 26, 2025

(51) Int. Cl. A63F 9/30

(52) U.S. Cl. CPC A63F 9/30

(57) ABSTRACT

A grasping apparatus includes a casing, a frame inserted in the casing, an electric motor connected to the frame, an elevating unit, a claw unit and adjusting units. The elevating unit includes a threaded rod operatively connected to the electric motor, a nut engaged with the threaded rod, bars connected to the lower cover and the frame, and a ring including a central orifice for receiving the nut and eccentric orifices for receiving the bars. The claw unit includes a hub, claws pivotally connected to the hub, and linking elements each of which includes a lower end pivotally connected to one of the claws and an upper end pivotally connected to the cylinder. Each of the adjusting units includes a threaded bolt with a head for contact with the hub and a spring including an upper section connected to the ring and a lower section engaged with the threaded bolt.

### BACKGROUND OF INVENTION

### 1. Field of Invention

The present invention relates to a claw machine and, more particularly, to a grip-adjustable claw unit of a claw machine.

### 2. Related Prior Art

Taiwanese Patent No. I760767 discloses a claw machine including a solenoid for switching a claw unit between an open position and a closed position. The claw unit is in the closed position to grasp a prize such as a doll. The claw unit is in the open position to release the prize onto a chute through which the prize comes out of the claw machine. However, the use of the solenoid for operating the claw unit fails to provide a grip expected to be adjustable in compliance with prizes which vary in weight and/or size.

Therefore, the present invention is intended to obviate or at least alleviate the problems encountered in the prior art.

### SUMMARY OF INVENTION

It is the primary objective of the present invention to provide a claw machine with a grip-adjustable grasping apparatus.

To achieve the foregoing objective, the grasping apparatus includes a casing, a frame inserted in the casing, an electric motor connected to the frame, an elevating unit, a claw unit and adjusting units. The elevating unit includes a threaded rod operatively connected to the electric motor, a nut engaged with the threaded rod, bars connected to the lower cover and the frame, and a ring including a central orifice for receiving the nut and eccentric orifices for receiving the bars. The claw unit includes a hub, claws pivotally connected to the hub, and linking elements each of which includes a lower end pivotally connected to one of the claws and an upper end pivotally connected to the cylinder. Each of the adjusting units includes a threaded bolt with a head for contact with the hub and a spring including an upper section connected to the ring and a lower section engaged with the threaded bolt.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a grasping apparatus of a claw machine according to the preferred embodiment of the present invention;

FIG. 2 is an exploded view of the grasping apparatus shown in FIG. 1;

FIG. 3 is an enlarged partial view of the grasping apparatus depicted in FIG. 2;

FIG. 4 is an enlarged partial view of the grasping apparatus depicted in FIG. 2;

FIG. 5 is a cross-sectional view of the grasping apparatus depicted in FIG. 1; and

FIG. 6 is an enlarged partial view of the grasping apparatus depicted in FIG. 5.

### DETAILED DESCRIPTION OF PREFERRED EMBODIMENT

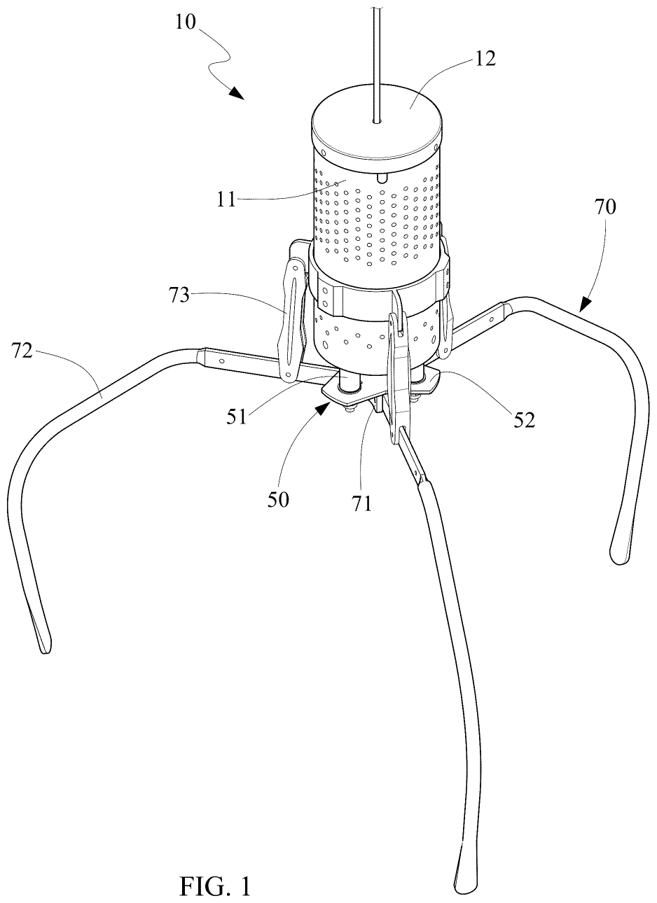

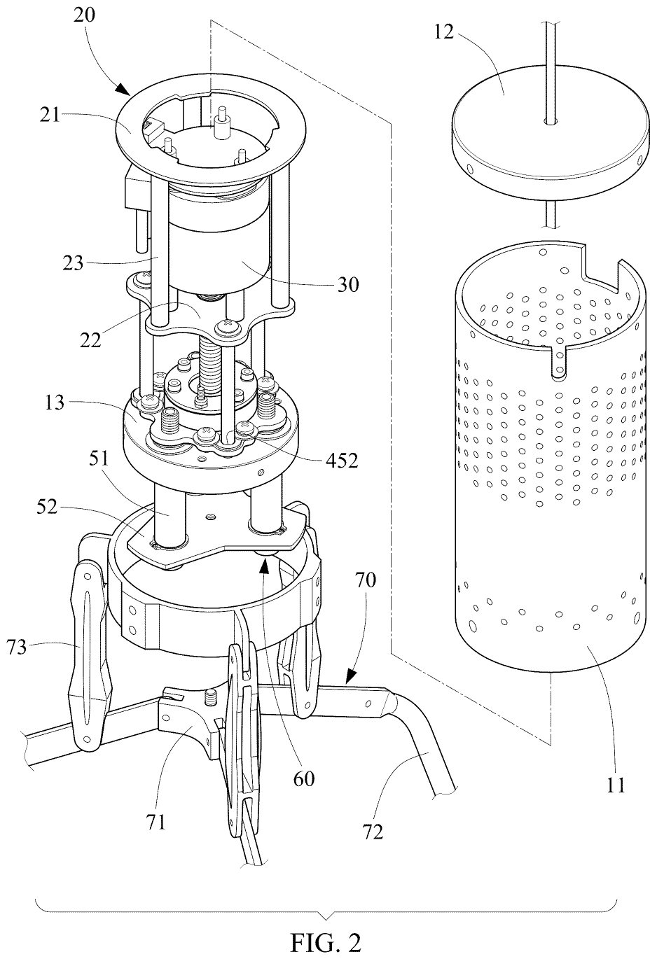

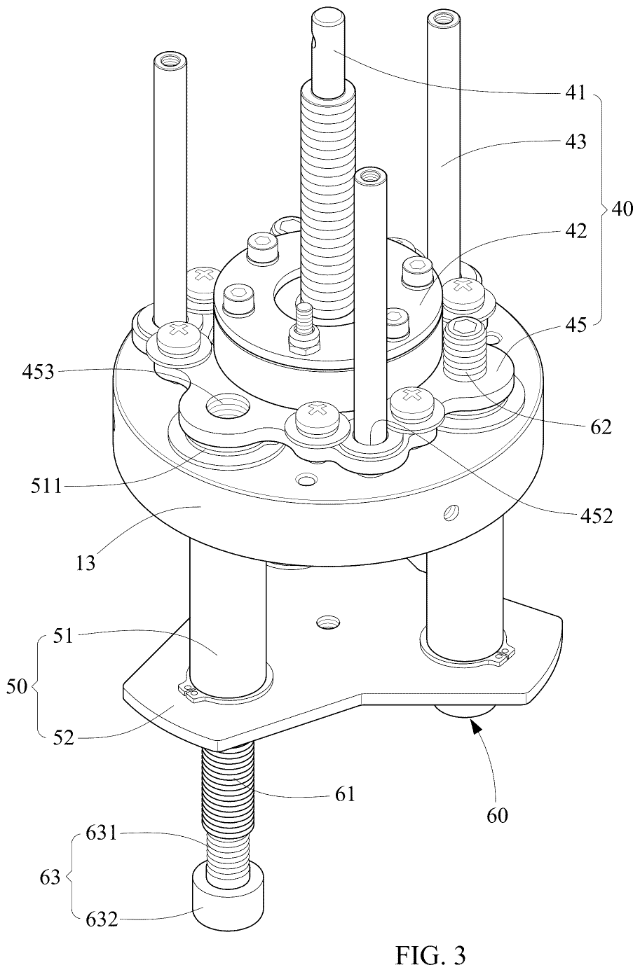

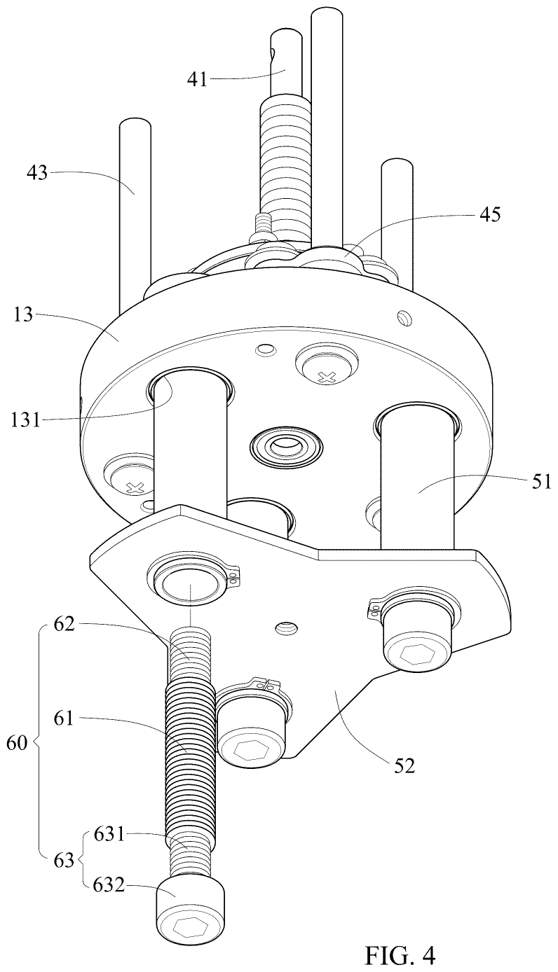

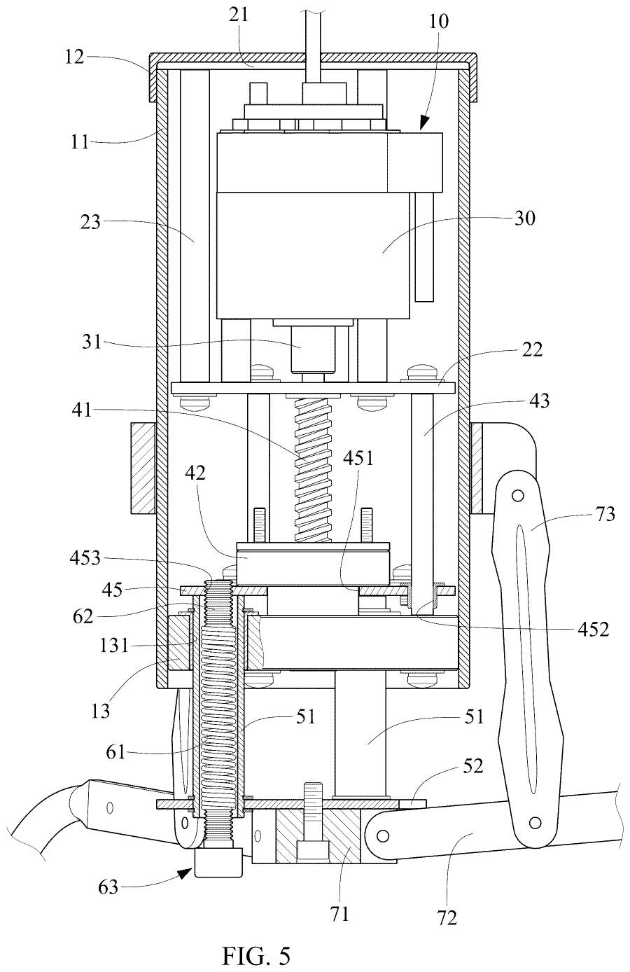

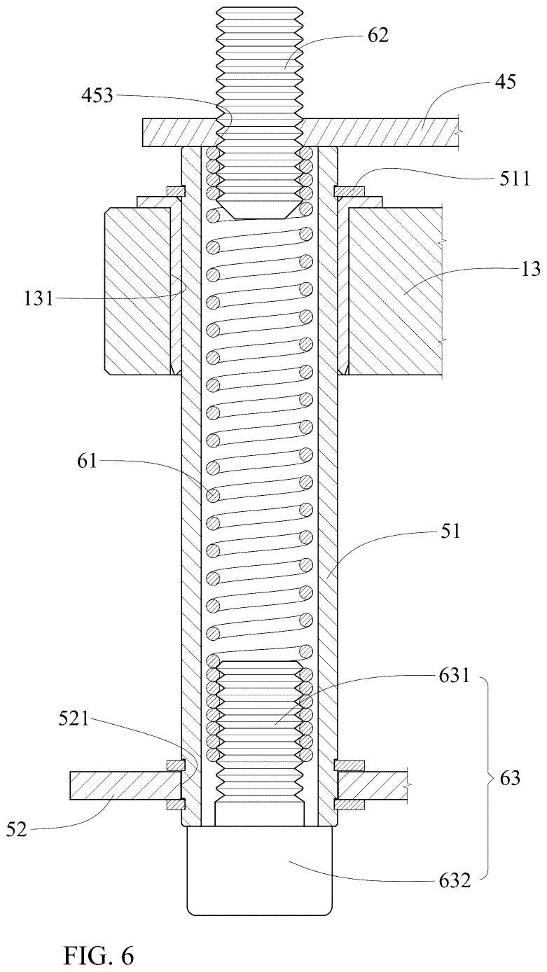

Referring to FIGS. 1 through 6, a grasping apparatus is devised for a claw machine. The grasping apparatus includes a casing 10, a frame 20, an electric motor 30, an elevating unit 40, a connecting unit 50, adjusting units 60 and a claw unit 70 according to the preferred embodiment of the present invention.

The casing 10 includes a cylinder 11, an upper cover 12 and a lower cover 13. The upper and lower covers 12 and 13 are attached to upper and lower open ends of the cylinder 11. The lower cover 13 is formed with apertures 131.

The frame 20 includes two plates 21 and 22 connected to each other by rods 23. Preferably, the plate 22 includes an opening (not numbered). The frame 20 is inserted in and attached to the cylinder 11 so that they are not movable relative to each other.

The electric motor 30 includes a mandrel 31. It should be noted that the electric motor 30 is activated to spin the mandrel 31 for a certain period in every round of the operation of the claw machine. The mandrel 31 spins in a first sense of direction as the electric motor 30 is activated. The mandrel 31 is allowed to spin in a second sense of direction when the electric motor 30 is not activated. The electric motor 30 is located on and attached to the plate 22 so that they are not movable to each other.

The elevating unit 40 includes a threaded rod 41, a nut 42, bars 43 and a ring 45. The threaded rod 41 is made with a high lead. The threaded rod 41 is connected to the electric motor mandrel 31 so that they are rotatable with each other. The combination of the threaded rod 41 with the mandrel 31 extends through the opening of the plate 22. The nut 42 is engaged with the threaded rod 41.

Each of the bars 43 includes an upper end connected to the plate 22 and a lower end connected to the lower cover 13. Thus, the bars 43 are not movable relative to the frame 20. Together, the bars 43 are used as a track in a manner to be described.

The ring 45 is made with a central orifice 451, eccentric orifices 452 around the central orifice 451, and screw holes 453 around the central orifice 451. The nut 42 is fitted in the central orifice 451 so that the nut 42 and the ring 45 are movable with each other. The term “eccentric” is used regarding the location, not the shape. Preferably, the eccentric orifices 452 and the screw holes 453 are arranged alternately. The ring 45 is connected to the nut 42 so that they are rotatable with each other. The eccentric orifices 452 receive the bars 43. Thus, the combination of the ring 45 with the nut 42 is not rotatable but movable relative to the bars 43, the frame 20 and the casing 10.

The connecting unit 50 includes tubes 51 and a disc 52. Each of the tubes 51 includes a flange 511 at an upper end. The tubes 51 movably extend in the apertures 131. Downward translation of the tubes 51 relative to the lower plate 13 is stopped on the moment when the flanges 511 contacts the lower plate 13. The disc 52 includes bores 521 for receiving the tubes 51. Clips (not numbered) are used to connect the tubes 51 to the disc 52 so that the disc 52 is movable together with the tubes 51.

Each of the adjusting units 60 includes a spring 61, a threaded rod 62 and a threaded bolt 63. The spring 61 includes an upper section with a lead identical to the lead of the threaded rod 62 and a lower section with a lead identical to the lead of the threaded bolt 63. The threaded rod 62 includes an upper section inserted in one of the screw holes 453 and a lower section engaged with the upper section of the spring 61 so that they are translated to each other when they are rotated relative to each other. The threaded bolt 63 includes a threaded section 631 engaged with the lower section of the spring 61 so that they are translated to each other when they are rotated relative to each other. The threaded bolt 63 includes a head 632 located out of one of the tubes 51.

The claw unit 70 includes a hub 71, claws 72 and linking elements 73. The hub 71 is connected to the disc 52 by a threaded bolt (not numbered) so that they are movable with each other. Each of the claws 72 includes an upper end pivotally connected to the hub 71 and a lower end for contact with a prize. Each of the linking elements 73 includes a lower end pivotally connected to a middle section of one of the claws 72 and an upper end pivotally connected to the cylinder 11.

To close claws 72 of the claw unit 70, the electric motor 30 is activated to spin the threaded rod 41 in the first sense of direction, thereby lifting the nut 42 as well as the ring 45. The ring 45 lifts the threaded rods 62 that lift the springs 61 that lift the threaded bolts 63. Eventually, the heads 632 of the threaded bolts 63 lift the tubes 51 that lift the disc 52 that lifts the hub 71 that lifts the upper ends of the claws 72. Thus, the lower ends of the claws 72 are moved downward and towards one another. That is, the claws 72 are closed to grasp a prize.

To open claws 72 of the claw unit 70, the electric motor 30 is turned off. The threaded rod 41 is allowed to spin in the second sense of direction, thereby allowing the nut 42 and the elements directly or indirectly connected to the nut 42 to drop because of weight. Thus, the upper ends of the claws 72 are lowered. Thus, the lower ends of the claws 72 are moved upward and away from one another. That is, the claws 72 are opened.

The adjusting units 60 are operable to adjust the grip of the claw unit 70. The threaded bolts 63 are rotated in a sense of direction to reduce the effective length of the adjusting units 60. Thus, the heads 632 of the threaded bolts 63 contact the disc 52 earlier and claws 72 are closed to an increased extent when the electric motor 30 is activated for the period of when the electric motor 30 is activated for the period. Hence, the grip of the claw unit 70 is increased.

On the contrary, the threaded bolts 63 are rotated in an opposite sense of direction to increase the effective length of the adjusting units 60. Thus, the heads 632 of the threaded bolts 63 contact the disc 52 later and the claws 72 are closed to a reduced extent when the electric motor 30 is activated for the period. Hence, the grip of the claw unit 70 is reduced.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A grasping apparatus comprising:
a casing (10);
a frame (20) inserted in and connected to the casing (10);
an electric motor (30) connected to the frame (20);
an elevating unit (40) comprising:
a threaded rod (41) operatively connected to the electric motor (30);
a nut (42) engaged with the threaded rod (41);
bars (43) connected to the frame (20) and the casing (10); and
a ring (45) comprising a central orifice (451) for receiving the nut (42) and eccentric orifices (452) for receiving the bars (43);
a claw unit (70) comprising a hub (71), claws (72) pivotally connected to the hub (71), and linking elements (73) each of which comprises a lower end pivotally connected to one of the claws (72) and an upper end pivotally connected to the cylinder (11); and
adjusting units (60) each of which comprises a threaded bolt (63) with a head (632) for contact with the hub (71) and a spring (61) comprising an upper section connected to the ring (45) and a lower section engaged with the threaded bolt (63).

2. The grasping apparatus according to claim 1, further comprising a connecting unit (50) comprising:
a disc (52) connected to the hub (71) and formed with bores (521); and
tubes (51) movably extending through the bores (521), wherein each the tubes (51) comprises at an upper end formed with a flange (511) for contact with the casing (10) and a lower end connected to the disc (52).

3. The grasping apparatus according to claim 1, wherein the casing (10) comprises a lower cover (13) connected to the cylinder (11), wherein the bars (43) are connected to the lower cover (13) and the frame (20).

4. The grasping apparatus according to claim 1, wherein the casing (10) comprises an upper cover (12) connected to the cylinder (11).

5. The grasping apparatus according to claim 1, wherein the threaded rod (42) is made with a high lead.

6. The grasping apparatus according to claim 1, wherein the frame (20) comprises a lower plate (22), an upper plate (21) connected to an upper end of the cylinder (11), and rods (23) each of which comprises lower end connected to the lower plate (22) and an upper end connected to the upper plate (21).

7. The grasping apparatus according to claim 6, wherein the electric motor (30) is attached to the lower plate (22) and comprises a mandrel (31) extending through the lower plate (22) and being connected to the threaded rod (41).

8. The grasping apparatus according to claim 1, wherein the ring (45) comprises screw holes (453), wherein each of the adjusting units (60) comprises a threaded rod (62) comprising an upper section inserted in one of the screw holes (453) and a lower section engaged with the upper section of spring (61).

9. The grasping apparatus according to claim 1, wherein the screw holes (453) are alternate with the eccentric orifices (452).
